(19) United States
(12) Patent Application Publication
(10) Pub. No.: US 2006/0150821 A1
(43) Pub. Date: Jul. 13, 2006

(54) Food preparation

(76) Inventors: Claire Cecilia Paul, Hampshire (GB); Paul Anthony Bottomley, Hampshire (GB); Mandy Nicola Haberman, Hetrfordshire (GB)

Correspondence Address: NIXON & VANDERHYE, PC, 901 NORTH GLEBE ROAD, 11TH FLOOR, ARLINGTON, VA, 22203, US

(21) Appl. No.: 10/559,656

(22) PCT Filed: Jun. 2, 2004
(86) PCT No.: PCT/GB04/02345

§ 371 Date: Dec. 5, 2005

(30) Foreign Application Priority Data
Jun. 6, 2003 (GB) 0313123.2

(51) Int. Cl. A47J 31/00

(52) U.S. Cl. 99/279

(57) ABSTRACT

A food preparation device comprising: a first water chamber for holding a volume of water to be boiled thereby to produce boiled water; and a second water chamber arranged to receive said boiled water and to hold said boiled water prior to: (a) the reheating of said boiled water, thereby to produce reheated water; and (b) the dispensation of said reheated water to a mixing location at which it can mix with concentrated food preparation formulation.

This invention concerns improvements in and relating to the preparation of food, including drinks and beverages. Hereinafter the term “food” includes drinks and beverages. The invention has particular application to hot food preparation devices, particularly but not exclusively to devices for assisting in the preparation of bottles of “formula” milk for a baby or toddler. Although the specification often refers to the food preparation formulation being powdered, it is to be understood that the invention is applicable to the preparation of food from liquid formulation, rather than powdered, concentrate. In addition, although the preferred solid form of the formulation is powdered concentrate, the concentrate may take alternative solid forms, such as soluble granules, solid cubes or tablets etc.

Formula milk for a baby or toddler requires boiled water to be added to formula milk powder. Boiled water must be used to ensure that the water is sterilized. However, at the time of mixing the sterilized water with the powder the water should not be boiling; instead it should be at a reduced temperature of approximately 45-55° C. If the water is at the incorrect temperature, mixing is poor—there can be a tendency for lumps of powder to result—and the nutrient value can be adversely affected.

In making up a bottle of formula milk it is conventional to boil water in a kettle or pan to help to sterilize it, wait for it to cool to approximately 50° C. and then add a measured dose of that cooled water to a baby feeding bottle. The formula milk powder may already have been placed in the bottle or else be added to the bottle following the addition of the hot, boiled water. Dosing of the formula milk powder into the bottle is usually achieved by tipping levelled off scoops of powder into the neck of the bottle, the number of scoops being in accordance with the powder manufacturer's directions for a baby or toddler of the age to be fed. This hand measuring of the dose of formula milk powder is less than ideal. Firstly, it is easy to loose count of the number of scoops of powder being added to the bottle, with a consequential risk of under or over dosing. This is particularly so if the baby or toddler to be fed is crying and/or other children are creating a distraction. Secondly, trying to pour the scoops of powder accurately through the narrow neck of a conventional feeding bottle can be difficult to achieve, especially when distractions are present, with the consequential spillage of powder affecting dosage concentration, making a mess and wasting the powder. Once the powder and water have mixed to form a bottle of formula milk the bottle may then be used to feed a baby or toddler, subject to it being cooled or heated to an appropriate feeding temperature if necessary. If, however, the bottle is being made in advance of being required, once it has cooled to room temperature it must be stored in a fridge and, when required, heated to an appropriate feeding temperature before being fed to the baby or toddler.

This procedure is not convenient. As will be appreciated from the above, if a baby or toddler should wake during the night and require feeding, in order to make up a bottle of milk at the time the baby or toddler wakes the need to obtain a supply of sterilized water at the correct temperature and to measure out the powder and water, whilst at the same time trying to comfort the child, can cause difficulties. An alternative might be to make a bottle up in advance, however in this case it is necessary to retrieve it from the fridge and to monitor its warming to an appropriate feeding temperature before the baby or toddler can be fed, all of which takes time and can cause stress. In addition, the fact that the bottle has been made up in advance can be undesirable for food hygiene and safety reasons.

A device suitable for use in the preparation of a bottle of formula milk is described in WO-A-97/47224, the contents of which are incorporated herein by way of reference. This device comprises a water tank in which water may be boiled by a heater. Once the boiled water has cooled down to a temperature below a predetermined dispense temperature, e.g. below approximately 45-55° C., the previously boiled water may be reheated to the predetermined temperature and discharged to a bottle received in a bottle-receiving station. If dehydrated formula milk powder has previously been added to the bottle, once water discharge is complete the bottle may be capped with a teat, shaken to mix the powder with the water and used to feed a baby or toddler. The water tank is removable from the device for easy refilling and/cleaning. When, however, the tank is removed from the device, the device is incapable of being used. Furthermore, where the reheating of the water is conducted in the water tank prior to discharge, it can be difficult to control the temperature of the water accurately due to low convention currents at low water temperatures. Furthermore, reheating the complete contents of the water tank, despite maybe only a small proportion of the tank being required to make up a bottle of baby formula, takes time and is an inefficient use of energy. In addition, multiple reheating of the previously boiled water is undesirable for reasons of water sterility. A further problem can arise after the water in the tank has been subjected to an initial sterilizing boil. In this situation, after the water has been boiled, the large volume of water in the tank can mean that it takes a significant period of the time for the boiled water to cool to the predetermined temperature, meaning that the device might be incapable of being used to make up a bottle of formula milk for quite some time after the water has been boiled to sterilize it.

According to a first aspect of the present invention there is provided food preparation device comprising:

a first water chamber for holding a volume of water to be boiled thereby to produce boiled water; and

a second water chamber arranged to receive said boiled water and to hold said boiled water prior to:

(a) the reheating of said boiled water, thereby to produce reheated water; and

(b) the dispensation of said reheated water to a mixing location at which it can mix with concentrated food preparation formulation.

The internal volume of the second water chamber is advantageously smaller than the internal volume of the first water chamber. As a consequence, the temperature of the reheated water may be controlled more accurately. Because the volume of the second water chamber is comparatively small, the heating means necessary to reheat water in the second water chamber can be fairly low powered, yet still achieve reheating within a reasonable time frame. By using a lower powered heating means than would be possible if a larger volume of water had to be reheated, more control can be exercised over the temperature of the water being reheated. In addition, because the second water chamber will usually be full during reheating, in contrast to the volume of the first water chamber, the water heater responsible for reheating will be operating on a known heating power to water volume ratio, again improving control. An additional benefit is that the desired amount of water may be reheated using less energy.

Advantageously the device further comprises a third water chamber, with the second water chamber being arranged to receive said boiled water from said first water chamber via said third water chamber. In this way, a large volume of water from the first water chamber can be boiled and spread between the second and third water chambers. The dispensing of the boiled water into two chambers can accelerate the cooling process, reducing the time period following a sterilizing boil during which the device cannot be used to prepare food. In addition, the device can be used to make a bottle of formula milk by reheating the boiled water in the second water chamber even when the first water chamber is being used to boil water and to pass that boiled water to the third water chamber.

In a preferred arrangement, the third water chamber is formed by a portion of the device which is separable from a further portion of the device forming the first and second water chambers. This can enable the separable portion of the device to be removed for cleaning of the third water chamber and/or to provide access to said first water chamber for cleaning and/or replenishment with water, whilst retaining a charge of sterilized water in the second water chamber meaning that (provided the second water chamber is not allowed to drain, and always contains at least one charge of boiled water) the device is always primed ready for use. The charge of boiled water in the second water chamber can thus act as a buffer minimising device “down time”.

A further advantage of boiling not being conducted in the downstream chamber (the second chamber) is a reduction in the formation of scale in the downstream chamber, which chamber is likely to be associated with moving parts which are susceptible to clogging, such as valves. Some salts in water can come out of solution when the water temperature is approximately 80° C. and higher. By restricting water at these high temperatures to the first and third chambers, both of which may readily be cleaned, the problem of scale buildup can be reduced.

According to a second aspect of the present invention there is provided a method of preparing food from concentrated food preparation formulation using a food preparation device, the method comprising the steps of:
(a) boiling a volume of water in the device thereby to produce boiled water;
(b) subsequently reheating at least some of said boiled water in a separate portion of the device to that in which the water was boiled thereby to produce reheated water;
(c) dispensing said reheated water to a mixing location; and
(d) mixing said dispensed water with said concentrated food preparation formulation at said mixing location.

According to a third aspect of the present invention there is provided a food preparation device, comprising:

a formulation receptacle for containing food preparation formulation;

a formulation dispenser for dispensing formulation from said receptacle to a mixing location;

at least one water chamber for the controlled dispensation therefrom of water to the mixing location; and

a water dispensation controller for controlling the dispensing of water from said at least one chamber to the mixing location;

wherein the device is, in use, adapted to contain a first volume of water and said water dispensation controller is operable to dispense to the mixing location only a portion of the first volume of water.

The water dispensation controller may be arranged to control the dispensing of water to the mixing location according to volume of water dispensed, time of water dispensation or weight of water dispensed or any combination thereof.

The portion of the first volume of water dispensed to the mixing location may advantageously be based on the amount of formulation conveyed, or to be conveyed, to the mixing location from the formulation receptacle.

The formulation receptacle may be arranged to contain a plurality of doses of formulation, with the formulation dispenser being operable to convey to the mixing location a single dose of the formulation. The formulation receptacle may comprise a plurality of discrete compartments, each for containing a dose of formulation, with the formulation dispenser being arranged to dispense to the mixing location the complete contents of at least one said compartment in a single formulation discharge operation. Alternatively, the formulation receptacle may be a bulk receptacle for the formulation, from which bulk receptacle a dose of formulation can be metered out at the time the dose is to be delivered from the formulation receptacle to the mixing location.

According to a fourth aspect of the present invention there is provided a method of preparing food from concentrated food preparation formulation using a food preparation device, the method comprising the steps of:
(a) providing the device with a first volume of water;
(b) dispensing formulation from a receptacle associated with the device to a mixing location;
(c) dispensing to said mixing location only a portion of said first volume of water; and
(d) mixing said dispensed water with said dispensed formulation at said mixing location.

Advantageously, in the methods of either or both of the above second and fourth aspects of the present invention the food preparation device is in accordance with either or both of the above first and third aspects of the present invention.

According to a fifth aspect of the present invention there is provided a food preparation receptacle for mounting in and/or on a food preparation device, the receptacle containing at least one discrete dose of concentrated food preparation formulation, which dose may be discharged from the receptacle on demand.

The receptacle of the fifth aspect of the present invention may be a sachet. The sachet may be provided with a form of closure which is arranged to be opened by the food preparation device on demand, which closure may for example take the form of a rupturable membrane which is broken. Once opened, the closure may in one arrangement be arranged to permit at least one dose of formulation to exit from the receptacle to a downstream mixing location. In an alternative arrangement, the opened closure may be arranged to permit the entry into the receptacle of water to mix with at least one dose of preparation at a mixing location within the opened receptacle. In this alternative arrangement, the mixed water and formulation could then be discharged from the opened receptacle to a downstream container. Alternatively, the receptacle could be disassociated from the food preparation device and the mixed water/formulation contained therein could be consumed by a user directly from the receptacle. In either case the receptacle would be disposed of after use.

According to a sixth aspect of the present invention there is provided a receptacle for mounting in and/or on a food preparation device and comprising at least two relatively movable parts, one said part defining a formulation discharge portion through which concentrated food preparation formulation may be discharged from the receptacle on demand, and the other said part at least partly defining a plurality of compartments for containing discrete doses of the formulation, a said dose being selectively dischargable from the receptacle in use by moving into registration the discharge portion and the compartment in which is contained the dose to be discharged.

In a preferred arrangement said at least two parts are relatively rotatable, whilst the receptacle is mounted in and/or on the food preparation device, either manually or by the device itself.

According to a seventh aspect of the present invention there is provided a food container for use with a food preparation device of the above first and third aspects of the present invention, wherein the container comprises a bottle-like portion having a dose of concentrated food preparation formulation sealably received therein.

In a preferred arrangement the bottle-like portion is sealably engageable with a portion of the food preparation device, for example via a screw thread or bayonet fixing, to establish and maintain a sterile environment in the interior of the bottle-like portion.

Advantageously the container takes the form of a bottle whose internal volume is capable of being increased following unsealing of the container, for example through the provision of a wall portion of the bottle with an expandable section in the form of a concertina or bellows. This enables the container to take up a reduced amount of space whilst being stored prior to use.

Embodiments of apparatus in accordance with the present invention will now be described, by way of example only, with reference to the accompanying drawings, in which:

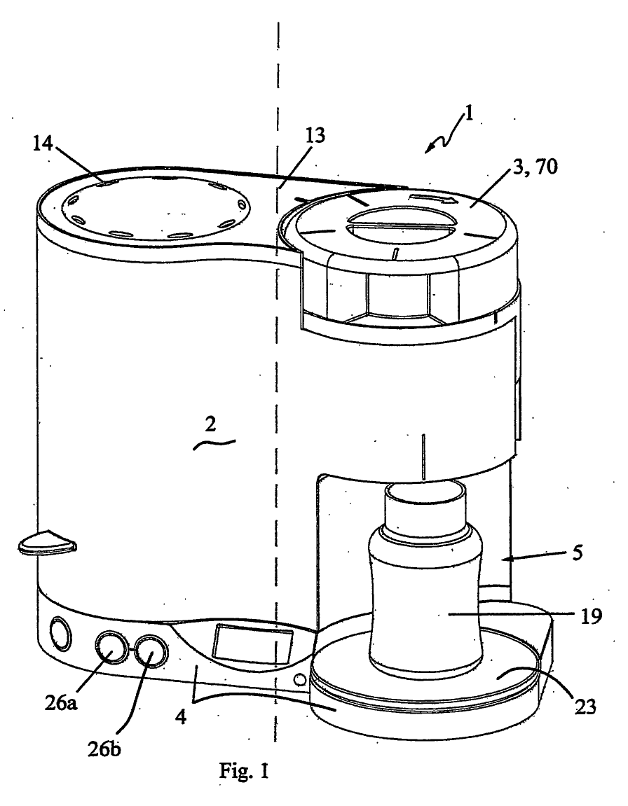

FIG. 1 shows, in perspective view from the front and above, a first embodiment of food preparation device;

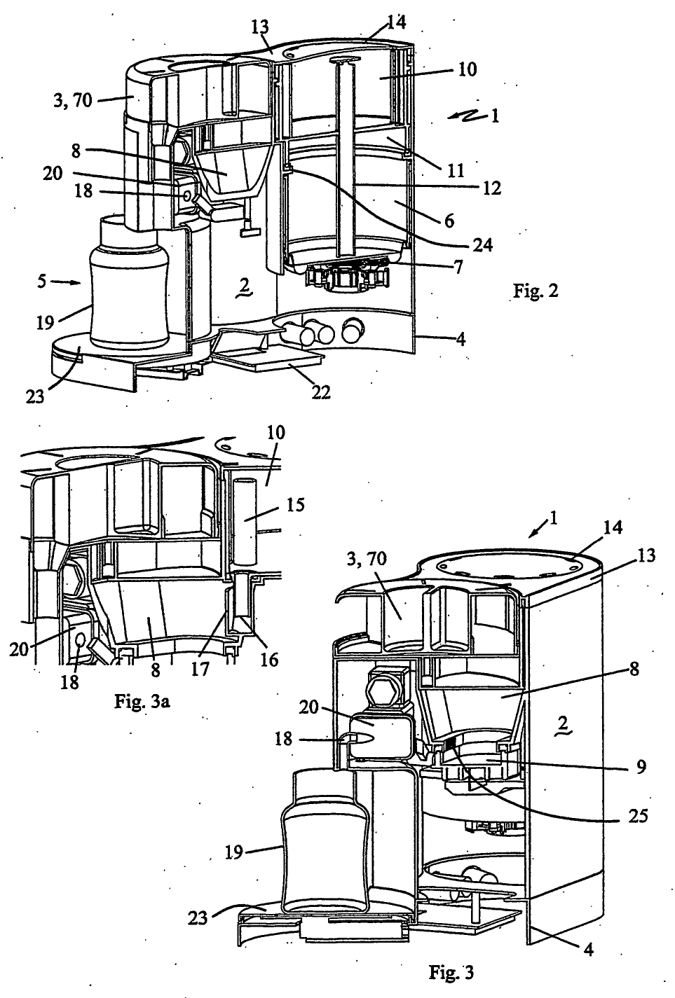

FIG. 2 is a sectioned view, from the rear, of the main unit 2 of FIG. 1;

FIG. 3 is also a sectioned view of the main unit 2 of FIG. 1, from the rear and one side;

FIG. 3a is a sectioned view, similar to that of FIG. 3, of part of the main unit of FIG. 1, but in a different plane so as to illustrate the weir arrangement at the entrance to the second water chamber;

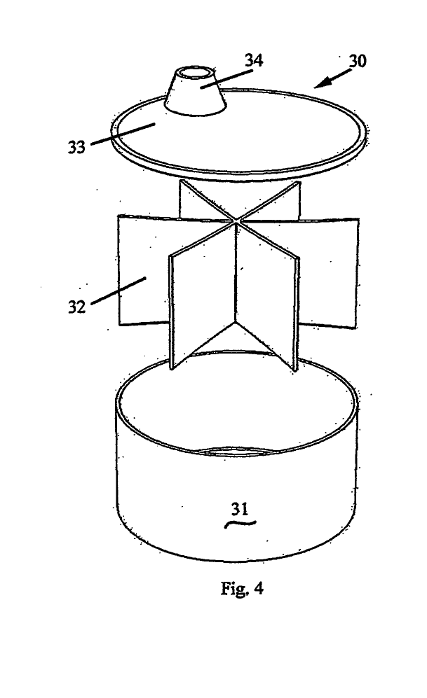

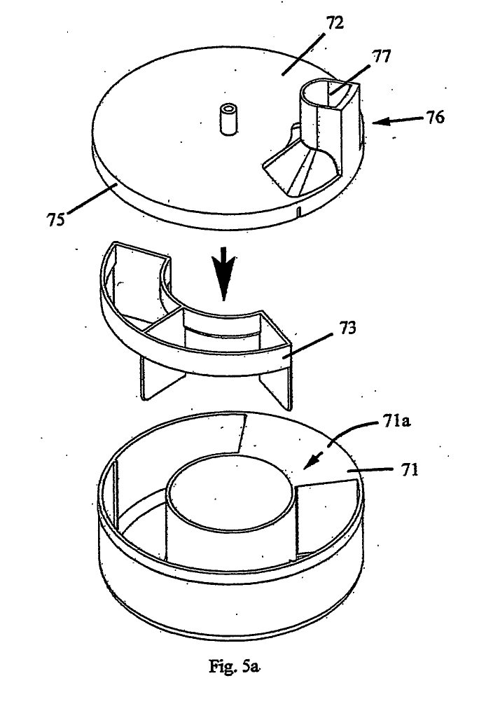

FIG. 4 is an exploded view of a first embodiment of formulation receptacle;

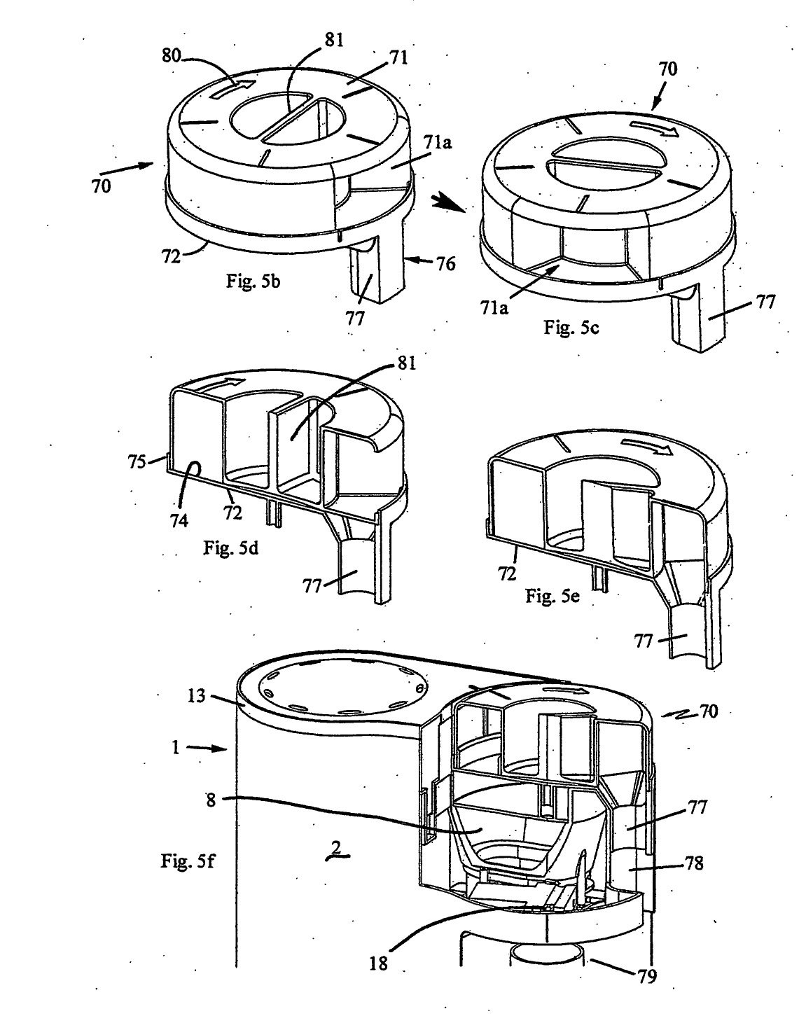

FIG. 5a is an exploded perspective view of a second embodiment of receptacle;

FIGS. 5b-5e show the components of FIG. 5a assembled together to form the second embodiment of receptacle (partially cut away in FIGS. 5d and 5e) during a sequence of operations;

FIG. 5f is a partial cutaway of the device of FIGS. 1-3 showing the second embodiment of receptacle (also partially cut away) mounted on the device;

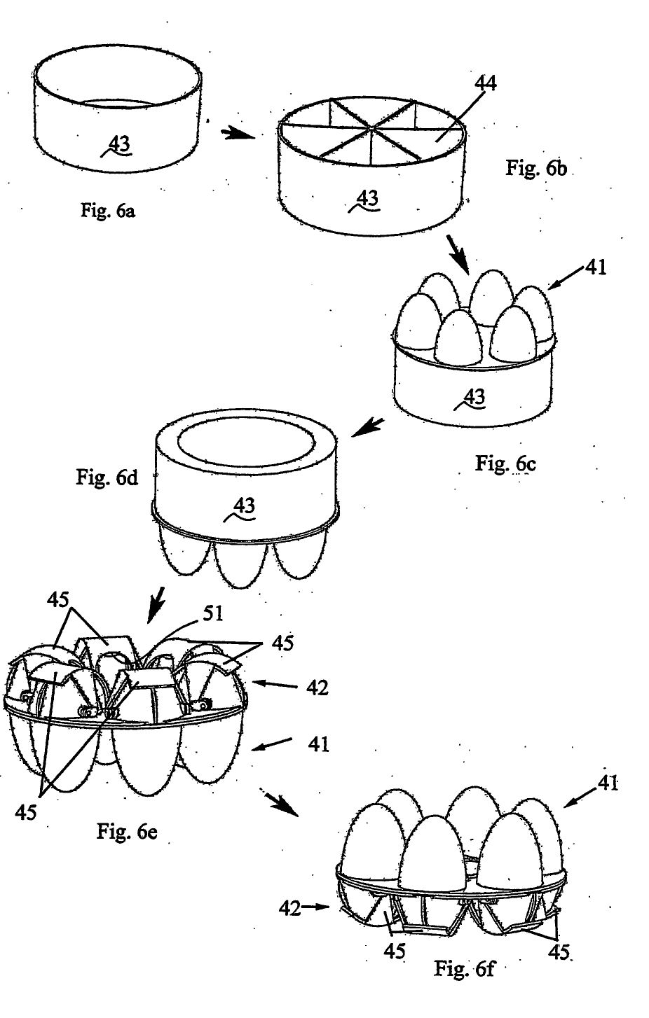

FIGS. 6a-6f illustrate a filling sequence for a third embodiment of receptacle;

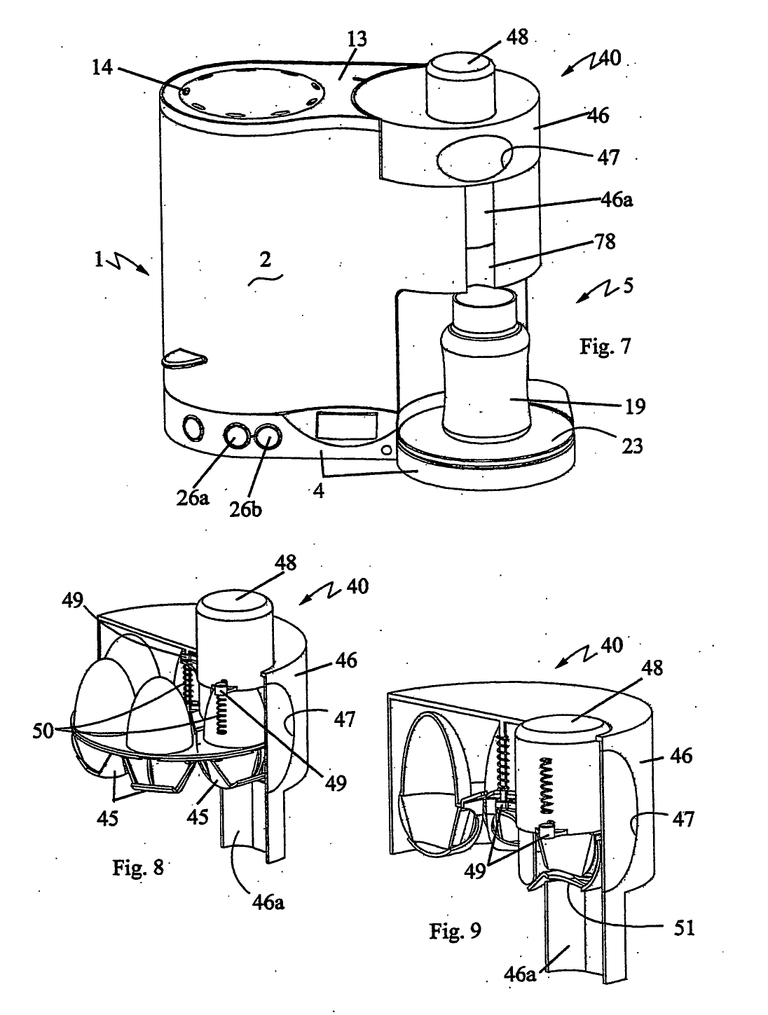

FIG. 7 illustrates, in a stylised arrangement, the third embodiment of receptacle mounted on the first embodiment of food preparation device;

FIGS. 8 and 9 show, schematically, a sequence of operations in which deformable compartments of the third embodiment of receptacle, of FIGS. 6e and 6f, may be successively deformed so as to discharge their contents;

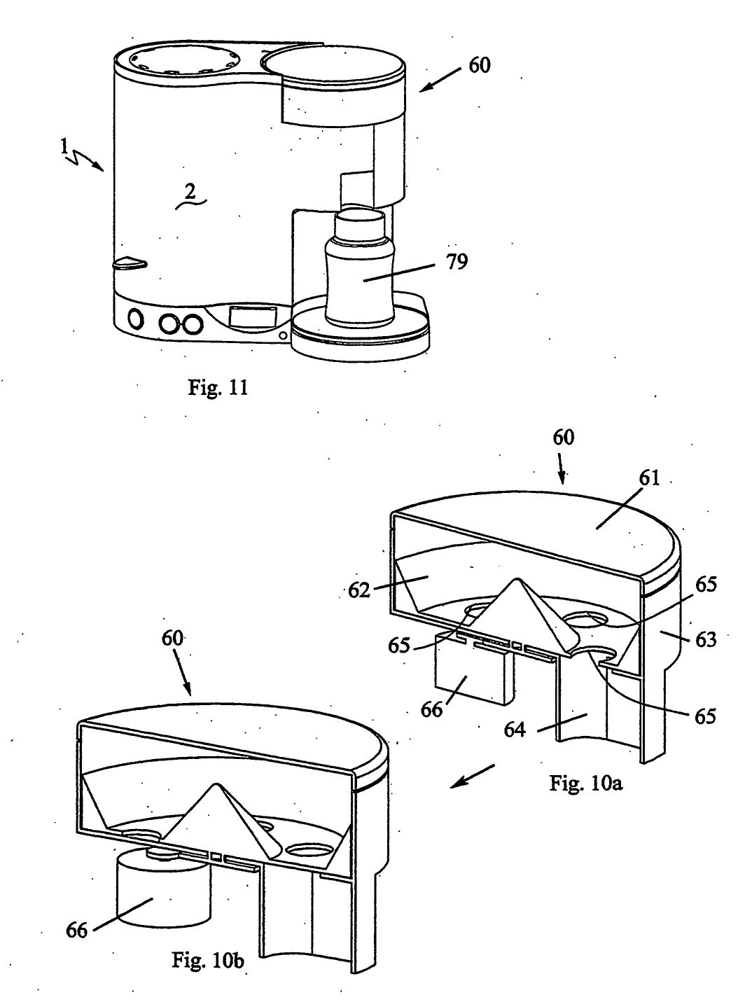

FIGS. 10a and 10b are two partial cutaway views of a fourth embodiment of receptacle;

FIG. 11 is a perspective view of the fourth embodiment of receptacle mounted in and on the food preparation device of FIGS. 1-3;

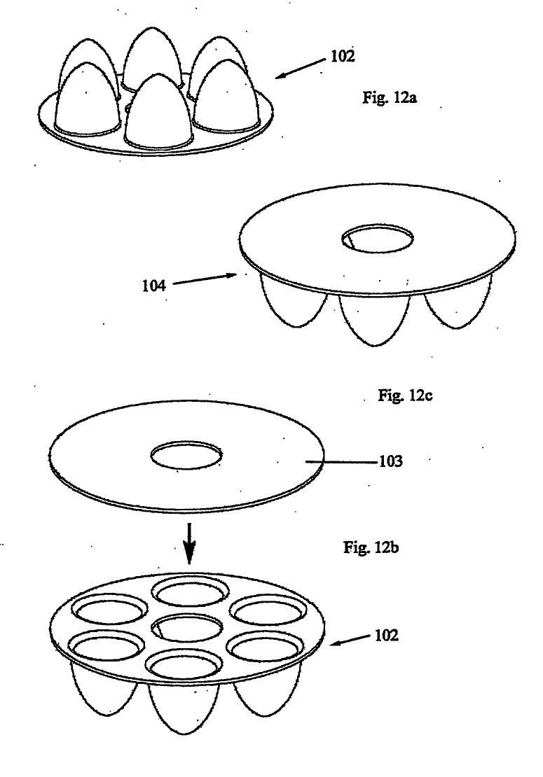

FIGS. 12a-12c illustrate a fifth embodiment of receptacle; and

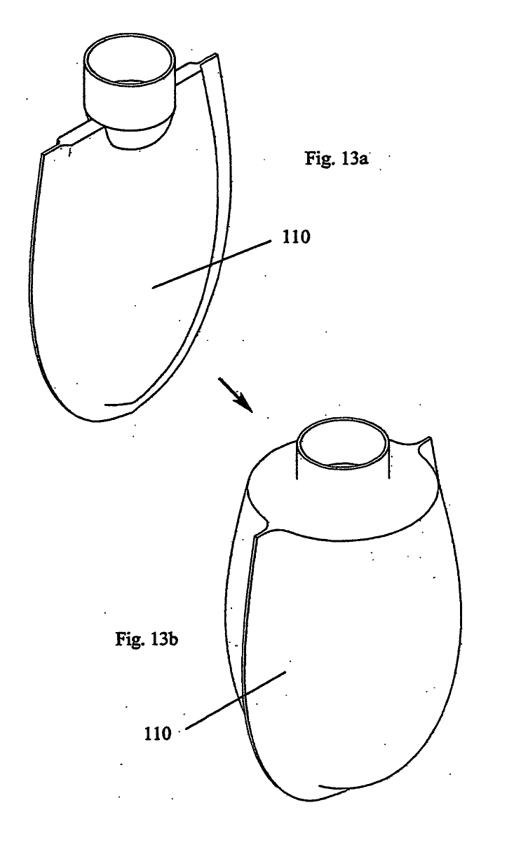

FIGS. 13a and 13b illustrate a sixth embodiment of receptacle.

The food preparation device 1 of FIG. 1 comprises a main, electrically operated unit 2 and a receptacle 3. In the illustrated embodiment the receptacle is the second embodiment of receptacle 70 described below, containing a plurality of doses of concentrated food preparation. The receptacle may, however, be to other designs and may alternatively contain only a single dose of preparation, as will also be described in more detail below.

In addition, although in the FIG. 1-4 embodiment of food preparation device both water and concentrated food preparation are dispensed to a bottle-receiving station of the device by the device, the device may be simplified so as only to dispense one of water and concentrated food preparation. Thus, a first food preparation device could be used to dispense a desired amount of concentrated food preparation to a bottle in a bottle-receiving station of the device, before the bottle is removed from the first food preparation device and water added to that bottle either manually or by a second, different food preparation device. Alternatively, the water may already have been added to the bottle (either manually or by a separate food preparation device) before the bottle is located at the bottle-receiving station of the first food preparation device.

For example, in the context of FIG. 1 the food preparation device may comprise only those components illustrated to the right-hand side of the vertical dotted line, omitting all water chambers, heaters and other items relevant to water handling.

The main unit 2 of the device 1 is advantageously mostly made from plastics material, due to its cheapness and ease of moulding. Those portions of the device which will be exposed to significant heat will need to be made of a material that is resistant to heat. Examples of such materials include a temperature-resistant plastics materials such as a talc-filled polypropylene.

The main unit 2 comprises a base 4, upon which is provided a bottle-receiving station 5 and a first water chamber 6. This first water chamber 6 is intended to hold a supply of water to be boiled in order to sterilize the water. In the illustrated embodiment the first water chamber is provided in its base with a first, electrically powered heater 7 operable to boil water held in the first water chamber 6. Although the heater 7 might be a conventional kettle-type heater element, it is envisaged that the heater could alternatively be a conventional induction type heater.

Situated within the main unit 2 alongside the first water chamber 6 is a second water chamber 8. In the illustrated embodiment this second water chamber 8 is provided with a second water heater 9 operable to reheat (if necessary) water held in the second water chamber. This second heater is also electrically powered and is restricted to reheating the water held in the second water chamber to a predetermined maximum temperature below boiling. If the reheated water is intended to be used to make up baby milk formula, the predetermined maximum temperature will be in the region of 45-55° C., i.e. substantially below boiling.

In the illustrated embodiment the portions of the main unit 2 forming the first and second water chambers 6, 8 are provided in a lower portion of the main unit 2. An upper portion of the main unit 2 forms a third water chamber 10. This upper portion of the main unit 2 is separable from the lower portion so as to enable the upper portion to be removed from the lower portion for cleaning of the third water chamber 10 and/or to provide access to the first and second water chambers 6, 8 for cleaning and/or replenishment of the first water chamber 6 with a fresh charge of water to be boiled.

The first water chamber 6 may be advantageously formed by a removable element (not shown) of the device 1, for example in the form of a jug. In this way, by removing the jug, the first water chamber 6 may be more easily replenished with water and cleaned. If the heater 7 does not require the jug to be provided with electrical contacts, the jug may for example be capable of being cleaned by being placed in a dishwasher.

Although in the illustrated embodiments the first water chamber 6 is manually charged with water, it is also envisaged that the device 1 may be plumbed into a water supply so that the first water chamber 6 will be refilled automatically on demand without the need for user intervention.

A downwardly depending circular collar 11 of the upper portion is, as shown, intended to form a snug fit within the upper end of the cylindrical first water chamber 6, thereby to function as a removable lid for the first water chamber 6. For reasons that will become apparent, the downwardly depending collar 11 may be provided on its external cylindrical surface with an O-ring or other sealing element (not shown) to seal against the internal cylindrical surface of the first water chamber 6.

Integrally formed with the separable upper portion is a conduit 12 which communicates between the interiors of the first and third water chambers 6, 10. This conduit 12 takes the form of a pipe having an inlet end positioned generally in the region of the base of the first water chamber 6, for example terminating just above the first water heater 7. The upper end of the conduit 12 extends through the base of the third water chamber 10, so that its outlet end is positioned, as shown, above the base of the third chamber 10 so as to prevent water in the third water chamber 10 below the level of the outlet end of the conduit 12 from draining back into the first water chamber 6 from the third water chamber 10. The third water chamber 10 is itself provided with a lid 13 which may, as shown, have a breather vent 14 to enable the escape of steam.

The first, second and third water chambers, 6, 8, 10, have first, second and third internal volumes respectively, and advantageously, as shown, the second internal volume is substantially smaller than both the first and third internal volumes.

To allow for the passage of water from the third water chamber 10 into the second water chamber 8, a flow controller is provided. This flow controller includes a pipe 15 integrally provided with the separable upper portion. This pipe 15 extends through the base of the third water chamber 10 down into the second water chamber 8 by a small amount (not shown). The pipe 15 extends upwardly (as shown in FIG. 3a) from the base to a height generally similar to the height of the top, outlet end of the conduit 12. The passage formed by the interior of the pipe 15 functions as a vent through which air may be displaced from the second water chamber 8, into the third water chamber 10, when water enters the second water chamber from the third water chamber. The downwardly depending stub of the pipe 15 (not visible in FIG. 3a) prevents the second water chamber 8 from overfilling.

The flow controller also includes a water inlet through which water may enter the second water chamber 8 from the third water chamber 10. This water inlet includes a weir arrangement made up of a downwardly depending pipe 16 formed as part of the separable upper portion, which pipe 16 terminates below the upper lip of a weir wall 17 formed as part of the lower portion. In this way, water flowing from the third water chamber 10 into the second water chamber 8 is required to pass down the interior of the pipe 16 and then flow upwardly over the weir wall 17 before entering the main volume of the second water chamber 8. In this way the rate of passage of water from the third water chamber 10 into the second water chamber 8 can be regulated, and ideally kept below the rate at which water can flow out of the second water chamber 8 through an outlet 18, only the downstream end of which is visible in FIG. 3 due to the angle of the section. As a consequence, upon dispensing water from the second water chamber 8 via the outlet 18, the level of water in the second water chamber will drop because the water will flow out of the chamber more quickly than it can be replenished and mixing will be reduced. Reduction of mixing is advantageous because the incoming water from the third water chamber may be significantly above the desired temperature of the water to be dispensed from the second water chamber 8, for example if boiling water has recently been transferred from the first water chamber 6 to the third water chamber 10.

In the illustrated arrangement the outlet 18 enabling water to pass from the second water chamber 8 to a bottle 19 received in the bottle-receiving station 5 is shown associated with a valve 20. In practice it is envisaged that this valve 20 will not be manually operated (although it may have a manual override), but will be subjected to fully automatic microprocessor control. For example, a microprocessor 22 may be provided in the lower portion of the main unit 2 and may also be used to control operation of many of the other components of the device, including the heaters 7, 9, as well as to control the discharge of heated water to the bottle 19 (and possibly also the administration to the bottle 19 of concentrated food or drink preparation formulation, as will be described in more detail below), for example based on multiple inputs including an input as to the weight of water and/or formulation dispensed into the bottle 19. In this last regard the bottle receiving station 5 may, as shown, include a weighing mechanism, with the flat plate 23 of the bottle-receiving station 5 acting as a weighing platform of the weighing mechanism.

An upper portion of the first water chamber 6 may, as shown, be provided with a valve 24, which valve is normally open (so as to vent the interior of the first water chamber 6) but which is closable in a condition associated with the onset of a cavitation during boiling of water in the first water chamber 6. The trigger for closing of the valve 24 may be the sensing of increased pressure in the first water chamber 6, or else it may be entirely temperature dependent, for example being activated by the microprocessor 22.

One method of operation of the first embodiment of the device will now be described, by way of example only. Other methods of operation will be apparent.

In order to prepare the device for initial use, the lid 13 and upper portion of the main unit 2 are removed and the first water chamber 6 is charged with a volume of water, which water may be from a tap because the water is to be sterilized in the device (as described below). The volume of water transferred into the first water chamber 6, for example 1 litre of water, may be such as to three quarters fill the chamber 6, with this amount of water representing sufficient water to make 4 bottles of milk formula where the bottles are to contain approximately 240 cc mixed feed. Of course, other numbers of bottles of different volumes may be employed. With the upper portion of the main unit 2 and/or the lid 13 removed it is envisaged that a switch or mechanical linkage will prevent operation of the first water heater 7 for reasons of safety. When, however, the upper portion is replaced, so as to assume the position shown in FIGS. 2 and 3 of the drawings, the switch or mechanical linkage enables operation of the first water heater 7.

The first water heater 7 need not be operated immediately after replacement of the upper portion. It would, however, be normal to operate the first water heater 7 at this juncture so as to commence a “boil” operation in order to produce a supply of boiled, sterilized water. Operation of the first water heater 7 may be achieved by pressing a “boil” button 26a on the front of the main unit 2, so as to cause the microprocessor 22 to supply power to the first heater 7.

At the start of the boil operation, the valve 24 is open. As the water in the first water chamber 6 is heated and boiled, steam will be produced and will be discharged through the vent valve 24. In the situation where the vent valve 24 is pressure operated, once a predetermined pressure is reached in the first water chamber 6 (this pressure being associated with the onset of cavitation), the valve 24 closes and the pressure in the first water chamber 6 increases rapidly. Pressurization of the first water chamber 6 will cause the boiling water to be forced up the conduit 12 into the third water chamber 10 until there is insufficient water in the first water chamber 6 to cover the inlet at the base of the conduit 12. The small amount of water remaining in the first water chamber 6 can be allowed to boil off. Conventional electronics for detecting the absence of water in the first water chamber, also called “dry boil”, may be provided so as to cause the microprocessor 22 to switch off the first water heater 7 in this situation.

When the boiling water reaches the third water chamber 10 from the first water chamber 6 via the conduit 12, it will spill into the base of the third water chamber 10 and start to cool. The initial charge of boiled water arriving in the third water chamber 10 will drain into the second water chamber 8 through the pipe 16, spilling over the weir wall 17. The inflow of water into the second water chamber 8 will cause air from the second water chamber 8 to be displaced up the pipe 15 into the third water chamber 10. The level of water in the second water chamber 8 will continue to rise until such time as air in the chamber can no longer escape up the pipe 15. Once no more water from the third water chamber 10 can flow into the second water chamber 8, all further boiled water arriving in the third water chamber 10 from the first water chamber 16 will be held in the third water chamber 10.

One now has a situation where all of the water in the second and third water chambers 8, 10 has been boiled and thus sterilized. In addition, at least the second water chamber 8 is charged with a supply of boiled, and thereby sterilized, water. The device might be left in this condition for many hours, during which time the boiled water in the second and third water chambers 8, 10 will cool, eventually approaching room or ambient temperature. In this regard, the smaller volume of the second water chamber 8 relative to the volume of the third water chamber 10 is likely to cause the water in the second water chamber 8 to cool more quickly than the water in the third water chamber 10.

The above described “boil” operation might be initiated upon putting an infant to bed, in order to prime the device ready for use (as will be described below) should the infant wake and require feeding. To prepare further for this eventuality a bottle 19 may advantageously have the appropriate amount of concentrated food preparation formulation, for example, powdered formula milk, manually measured into it and be capped and left alongside the device 1. Alternatively, as described below, if the device 1 has a facility for itself dispensing the requisite amount of powder to the bottle 19, or else is arranged to mix reheated water with powder at a mixing location within the device upstream of the bottle 19, it would not be necessary manually to pre-dose powder into the bottle 19 prior to insertion of a bottle into the bottle-receiving station 5.

A common scenario envisaged for this device is that several hours after leaving the device in the above condition, an infant will wake and require urgent feeding. How long the infant has been asleep, and how long the water has had to cool, will dictate the temperature of the boiled water in the second and third chambers 8, 10. Suppose, for example, that the infant has been asleep sufficiently long for the temperature of the water in at least the second water chamber 8 to have descended below 45° C., such that the water is too cold to be used to make up a bottle of baby milk formula without first being reheated. This temperature may readily be determined by a temperature sensor 25 associated with the second water chamber 8, the output of which sensor 25 is an input to the microprocessor controller 22.

In this situation, in order to commence preparation of a bottle of feed, the user may uncap the bottle 19 previously positioned adjacent the device 1 and place it on the bottle-receiving station 5 with its open mouth underneath the outlet 18 of the valve 20. Upon pressing a “feed” button 26b to initiate a feed preparation operation, the microprocessor controller 22 determines that the temperature of water in the second water chamber 8 is too low and thus activates the second heater element 9 to increase the temperature of the water in the second water chamber 8. Upon the temperature sensor 25 sensing that the temperature of water in the second water chamber 8 has risen to the predetermined 45-55° C. temperature range, the valve 20 may be automatically opened under control of the microprocessor controller 22 and water of the appropriate temperature allowed to pass from the second water chamber 8 into the bottle 19 via the outlet 18. The microprocessor controller 22 also terminates operation of the second water heater 9. Where the bottle-receiving station 5 is associated with a weighing apparatus, which apparatus provides an input to the microprocessor controller 22, that controller can automatically close the valve 20 once an appropriate weight of heated water has been discharged from the second water chamber 8 to the bottle 19.

In the event that the infant had awoken whilst the temperature of the water in the second water chamber 8 was in the predetermined temperature window (45-55° C. in the present example), upon pressing the “feed” button 26b the microprocessor controller 22 could simply have opened the valve 20 without initiating operation of the second water heater 9. It will thus be appreciated that the second water heater 9 need not be operated every time the device is used to deliver water to the bottle-receiving station 5. It is operated only when required, according to the temperature of the water in the second water chamber 8.

If, however, the infant had awoken before the temperature of water in the second water chamber 8 had fallen sufficiently as to be in the above-mentioned safe temperature window (45-55° C.), an audible warning could be sounded and/or the microprocessor controller 22 could decline to open the valve 20 thereby preventing the bottle from being made up with heated water that might be dangerously hot. The latter of these two options is preferred for reasons of safety.

It will be appreciated that, when the microprocessor controller 22 opens the valve 20 such that water flows from the second water chamber 8, the level of water in that chamber will tend to drop, thereby permitting more boiled water to flow into the second water chamber 8 from the third water chamber 10. The incoming water from the third water chamber 10 might be of a temperature outside of the above-mentioned 45-55° C. temperature window. One way of avoiding problems in this regard is to minimise mixing between the incoming and outgoing water in the second water chamber 8. This can be achieved by having the water inlet to the second water chamber 8, represented by the pipe 16 and weir wall 17, positioned at an opposite end to the second water chamber 8 to the outlet 18, such that by the time the water entering the second water chamber 8 from the third water chamber 10 has travelled across the width of the second water chamber 8 the bottle 19 will be full such that the valve 20 will have been closed by the microprocessor controller 22, before the incoming charge of water (of uncertain temperature) from the third water chamber 10 can be discharged. If, however, a particularly large bottle 19 is required to be filled, in this situation, the temperature sensor 25 associated with the second water chamber 8 will detect that the new temperature of the water contained in the second water chamber 8 is now outside the dispense temperature window causing the microprocessor controller 22 to close the valve 20. If the detected temperature of water in the second water chamber 8 is sensed to be below the dispense temperature window the microprocessor controller 22 can activate, or reactivate, the second water heater 19 to bring the temperature of the water in the second water chamber 8 up to the required temperature window.

In the illustrated embodiment, the first and second water heaters 7, 9 are provided in the first and second water chambers, 6, 8 respectively. Consequently, water is boiled in the first water chamber and then transferred to the third water chamber 10. In addition, if reheating of water in the second water chamber 8 is required to the reheated water being discharged to a bottle 19, the water is reheated whilst in the second water chamber 8. The heating elements need not, however be physically provided in their respective water chambers.

For example, in the context of the first water chamber 6, a syphon-type in-line water heater may be provided to take cold water from the first water chamber 6, to boil it after its removal from the first water chamber 6, prior to depositing the boiled water in the third water chamber 10. Such syphon-type in-line heaters are well known from filter coffee makers and the like. Similarly, an in-line heater may be associated with the second water chamber 8, so that any reheating of water from the second water chamber 8 may actually occur outside of the second water chamber 8 during the course of the passage of the water from the second water chamber 8 to a mixing location at which the reheated water is to be mixed with concentrated food preparation formulation. In the illustrated embodiment this mixing location is the bottle-receiving station 5 at which bottle 19 is located. The mixing location may, however, be within the device, as will be explained below.

Where an in-line water heater is provided this may be associated with an elongate temperature sensor commonly known as a “rod stat”. In the situation where an in-line heater is used to reheat water upon exiting the second water chamber 8, if the microprocessor controller 22 learns from the rod-stat associated with the in-line heater that the temperature of the water to be dispensed will be too hot, a bleed supply may be opened by the controller 22. It is envisaged that this bleed supply would take water from the second water chamber 8 and mix it with the water reheated by the in-line heater, with the mixed amounts being dependent upon the temperatures of the two sources of water being mixed.

By way of explanation, in this specification, the term “boiled water” is used to describe water in the second and third water chambers 8, 10. The term “boiled water” means water from the first water chamber 6 which has been boiled, and which may either still be at or close to boiling or else have cooled to a temperature at which it is well below boiling. If the water has been left to cool for long enough, the temperature of the “boiled water” may be at or approaching room temperature.

The level of water in each of the first, second or third water chambers 6, 8, 10, may be monitored by a user using transparent sight windows (not shown) provided in the casing of the main unit 2. When the user notices, for example, that there is comparatively little boiled water in the third chamber 10, or that the third water chamber 10 is completely empty with water only left in the second water chamber 8, the decision can be taken to sterilize a fresh batch of water. In this situation, the lid 13 can be removed from the third water chamber 10 and the upper portion removed by grasping an integral handle (not shown) and lifting the upper portion to separate it from the lower portion of the main unit 2. By positioning the handle towards the base of the third water chamber 10, a user can be discouraged from refilling the device too often. Refilling it prematurely will result in the user having to wet his or her hand, hence the discouragement.

As an alternative, or as a complement, to the abovementioned sight windows (not shown) the device may be provided with a visual and/or audible indicator (not shown) which indicates to the user when the first water chamber 6 needs refilling.

As a yet further alternative, the microprocessor 22 may be capable of detecting the amount of water discharged to a bottle-receiving station 19, either by measuring the volume of water discharged, by summing the weight of water discharged (via the weighing mechanism 23) or through the use of an optical sensor or reader. In this way the microprocessor will be capable of knowing the volume of water discharged and thus the volume of water remaining within the device 1. Using this information it can signal the user to refill the device manually. Alternatively, as mentioned above, if the device 1 is plumbed into a piped water supply, the microprocessor controller could simply admit a fresh charge of water to the device 1 without the need for the device user to intervene manually.

At all events, once the upper portion of the device has been separated from the lower portion, the third water chamber 10 can be cleaned and a fresh charge of cold water can be tipped into the first water chamber 6. Although, as described earlier, in this condition with the upper portion removed it is envisaged that the first water heater 7 should be rendered incapable of operation, it is considered appropriate for the second water heater 9 to be capable of operation in this condition. The reason for this is that the maximum water temperatures generated in the second water chamber 8 would, in the illustrated example, be sufficiently low as not to represent a potential scalding problem. As a result, it will be appreciated that the device can be left primed, ready for immediate use, even during routine servicing.

In addition, once the first water chamber 6 has been replenished and the upper portion of the device and lid 13 replaced, subsequent activation of the first water heater 7 to boil, and thereby to sterilize, the fresh charge of water will not prevent the device from being used, either whilst the first water heater 7 is actually boiling the water, or during the time period following the first heater's activation during which boiled water is still cooling in the third water chamber 10 to a temperature within the dispense temperature window. Provided that, when the first water chamber 6 was replenished and a “boil” operation initiated, the second water chamber 8 was fairly full, comparatively little freshly boiled water at high temperature will be able to flow from the third water chamber 10 into the second water chamber 8, such that the temperature of water in the second water chamber 8 should not rise appreciably. Consequently, in many situations the device will be capable of being used to make up a bottle of baby formula during or shortly after conducting of a sterilizing boil of water in the first water chamber 6. This contrasts with the situation encountered in the above-mentioned WO-A-97/47224, where following a sterilizing boil of water in the water tank, the device cannot be used to make up a bottle of baby formula until such time as the temperature of all the boiled water in the tank has descended to be in the appropriate temperature window.

In order to avoid the above-discussed problem of dosing formula milk powder into a bottle by tipping a plurality of levelled off scoops of powder into the narrow neck of the bottle, it is envisaged to provide a receptacle for the powdered food preparation formulation, which receptacle may be used to facilitate the delivery of correct doses of powder into bottles in which the doses of powder are to be mixed with water.

In a first embodiment, illustrated in FIG. 4, the formulation receptacle 30 comprises a drum-shaped container 31, a multi-vaned element 32 and a lid 33 having a formulation discharge portion in the form of a funnel-shaped discharge port 34. It is envisaged that all three components 31, 32, 33 of the receptacle 30 will be made of an appropriate plastics material. The top edge of the drum-shaped container 31 and the underside lip of the lid 33 are provided with a resealable lock, similar to that found on a resealable food storage container, which, when the lid 33 is pressed on to the container 31, causes the two elements to be held together (yet be relatively rotatable), with the vaned element 32 received therebetween, flush with the base of the container 31 and the underside of the lid 33.

The receptacle 30 is intended to be used for gravimetric pre-dosing of food preparation formulation, such as formula milk powder. The receptacle 30 simplifies the dosing, removing the need for careful measurement with scoops, and the need to count the number of times a scoop is emptied into a bottle. In addition, the receptacle 30 helps to reduce the likelihood of spillage of formulation in transferring the doses of formulation into bottles. The receptacle 30 also has the advantage of enabling a prospective user of the device to move the dosing process to a preparation step, in which the device is being prepared for use some time ahead of being needed, rather than having to measure out a dose of formulation at the time it is needed, for example when a baby or toddler requires urgent feeding.

One possible method of use of the formulation receptacle is to remove the lid 33 from the drum-shaped container 31, and then to remove from the interior of the container 31 the vaned element 32.

The container 31 is then placed on a set of scales. Sufficient formulation for a plurality of doses (the number of doses being equivalent to the number of vanes of the multi-vaned element 32) is then poured into the container 31. This amount of powder is measured by weight, using the powder manufacturer's guidelines as to the weight of a dose.

The formulation in the container 31 may be levelled, either by gently shaking the container 31 or using a secondary plastic disc (not shown). Once the powder is levelled, the multi-vaned element 32 can be inserted into the container 31, with the vanes of the element 32 dividing the complete charge of powder into a plurality of compartments each containing an equal quantity of powder, each said quantity advantageously comprising a single dose of powder.

The multi-vaned element 32 has a height corresponding to the interior height of the container 31. By clipping the lid 33 onto the container 31 a plurality of discrete compartments (six in the case of the illustrated embodiment) are provided, each containing an equal dose of food formulation.

So as to prevent rotation of the element 32 relative to the container 31 a plurality of small projections (not shown) may be provided on the interior wall of the container 31 to cooperate with one or more of the vanes. The lid 33 is, however, rotatable relative to both the container 31 and the vaned element 32. In this way the funnel-shaped discharge port 34 of the lid 33 can be rotated sequentially into registration or alignment with each of the six compartments formed by the multi-vaned element 32. By sequentially indexing the discharge port 34 into alignment with different ones of the compartments formed between the vanes of the multi-vaned element 32, and inverting the formulation receptacle 30 from the position shown in FIG. 4, it will be appreciated that if the exit of the funnel-shaped discharge port 34 is received in the neck of a bottle prior to inversion the powdered formulation contents of a single receptacle can be dispensed into that bottle, without the need to keep count of a number of scoops, try to pour the contents of multiple scoops into a bottle etc. In this way, providing a bottle with an accurately measured dose of powdered formulation may readily be achieved.

The receptacle 30 may be kept alongside the food preparation device and be used manually to provide a dose of formulation into a bottle 19, before that bottle is placed in the bottle-receiving station 5, using the above described technique. In this way the main unit 2 of the device is not required to administer a dose of formulation to a bottle 19, only water.

In a modification of the above, the receptacle may be mounted in or on the device 1 as explained below.

FIGS. 5a-5f illustrate an alternative construction of receptacle 70. This second embodiment of receptacle 70 is similar in concept to the first embodiment of receptacle 30 of FIG. 4 but is intended to be mounted on the device 1 (as shown in FIG. 5f) to provide the device 1 with the facility for dispensing a dose of formulation.

In FIGS. 5a-5f, the receptacle 70 is comprised of three main components: container 71, lid 72 and vaned component 73.

In common with the FIG. 4 first embodiment of receptacle 30, in the FIG. 5 second embodiment of receptacle 70 the container 71 is inverted (to the orientation shown in FIG. 5a) and a known amount of powder placed in an arcuate segment around its periphery. In contrast, to the FIG. 4 arrangement, the container 71 of FIG. 5 has a hollow center, as well as an arcuate cut-out segment 71a, divided from the main powder-receiving segment by partitions. By shaking the container 71 and then pressing the vaned component 73 into the container 71, the powder in the main arcuate segment of the container 71 can be divided into a plurality of individual compartments each containing an equal quantity of powder, each quantity advantageously comprising a single dose of powder.

The lid 72 comprises a flat surface 74, with a circumferential lip 75 which is arranged to mate with the lip of the container 71 so as to allow the container 71 and lid 72 to be relatively rotated, whilst still being held together.

The flat surface 74 of the lid 72 is provided with a formulation discharge portion 76 in the general form of a funnel. It will be noted that the footprint of the formulation discharge portion 76 is the same as the footprint of a compartment between adjacent vanes of the vaned component 73. By attaching the lid 72 to the container 71 with the formulation discharge portion 76 aligned with the arcuate segment 71a of the container 71, the assembled receptacle 70 may then be inverted (from the orientation shown in FIG. 5a) to assume the orientation shown in FIGS. 5b-5f without powder falling through the formulation discharge portion 76. This condition is illustrated in FIGS. 5b and 5d.

It will be noted that the formulation discharge portion 76 comprises a discharge portion 77 which (in the orientation shown in FIGS. 5b-5f) depends downwardly from the underside of the lid 72. When the receptacle 70 is mounted on the device 1, as shown in FIG. 5f, this downwardly depending discharge portion 77 is fitted into a powder receiving conduit portion 78 of the device 1. As can be seen in FIG. 5f, a bottle 79 (the upper portion of whose neck only is visible) is positionable underneath the powder receiving conduit portion 78 so as to receive therethrough a dose of powder from the receptacle 70 when the receptacle is used in the manner described below. (In FIG. 5f the bottle 79 is not aligned with the powder receiving conduit portion 78, for reasons which will be explained below, but it can be moved laterally to be so aligned).

Upon indexing the container 71 (and the vaned component 73 rotationally fast therewith) by rotating it relative to the lid 72 in the clockwise direction represented by arrow 80, from the FIGS. 5b (and 5d) condition to the FIG. 5c (and 5e) condition, a first powder-filled compartment within the receptacle 70 can be moved into registration with the discharge portion 77 (as most clearly shown in FIG. 5e), thereby allowing the contents of that compartment to fall through the discharge portion 77, through the powder-receiving conduit 78, into a bottle 79 aligned therewith.

If the powder contents of a single compartment in the receptacle 70 equal a single dose of powder, the receptacle 70 can be indexed once to charge a single bottle 79. It is, however, envisaged that, in order to allow different size bottles of feed to be made up, a “dose” of powder may, in fact, comprise a plurality of compartments' worth of powder, so that the receptacle would need to be indexed sequentially an appropriate number of times.

Although in the illustrated embodiment the lid 72 and vaned component 73 are rotated relative to the lid 72 (and the device 1) by manual indexing via a handle 81, it is envisaged that the device 1 may be provided with a motor (not shown) controlled by the microprocessor controller 22 so as to allow for automatic indexing, and thus automated powder charging.

In the arrangement illustrated in FIG. 5f the powder-receiving conduit 78 is shown as being displaced, in the circumferential direction, from the conduit 82 through which water is discharged from the second water container 8 to a bottle 79 in the bottle-receiving station. In this way, a bottle may be first charged with powder in the manner described above and then moved laterally to the position shown in FIG. 5f so as to be ready to receive reheated water from the second water chamber.

In the modified arrangement of the device illustrated in FIG. 5, when a user wishes to make up a bottle of milk formula for example, much of the method described above in conjunction with the FIG. 4 receptacle is followed. The difference is that, instead of placing a bottle 79 filled with a dose of formulation into the bottle-receiving station, an empty bottle 79 is inserted into (or is already present) in the bottle-receiving station, with the neck of the bottle 79 aligned with the powder receiving conduit portion 78. When it is required to make up a bottle of feed, a compartment of the receptacle 70 can be rotated into registration with the formulation discharge portion 76 and the powder-receiving conduit portion 78, thereby to discharge a known amount of formulation into the aligned bottle 79 (not shown). By then moving the bottle 79 laterally (to the position shown in FIG. 5f, to align the neck of the bottle 79 with the water outlet 18) the action of pressing the feed button 26b can be used to trigger the microprocessor controller 22 to discharge to the bottle 79 an appropriate amount of water at an appropriate temperature.

In this way one avoids the need for the user manually to deposit a dose of powdered formulation into the bottle 79 prior to the bottle's insertion into the bottle receiving station, bringing an increasing level of automation to operation of the device 1.

In the situation described in the above paragraph, the device 1 may be arranged to discharge into the bottle 79, from the second water chamber 8, a fixed amount of water corresponding to the amount of powdered formulation forming a dose of formulation. The device 1 might measure out the amount of water being discharged to the bottle 79 under the control of one or more of: a flow measurement device integrated into the valve 20; a timer (not shown) arranged to open the valve 20 for a fixed time interval; the weight of water dispensed, this weight being sensed by the weighing mechanism 23; and the level of water in the bottle (for example employing an optical sensor or reader to monitor water level). Some or all of these three exemplary inputs may be fed to the microprocessor controller 22 for it to regulate operation of the valve 20. Alternatively, the device may be arranged to employ a measuring device within the device 1, in the manner of a pub-style optic, to dispense a predetermined fixed volume of reheated water.

Whilst the discharge of a fixed amount of water into the bottle 79 is fine if the complete contents of a compartment in the receptacle 70 are successfully transferred from the receptacle 70 into the bottle 79, underdosing can arise if not all of the powder is successfully transferred. Milk powder formulation does not readily “flow” in the manner of a liquid, particularly once it has been exposed to moisture, so if the formulation received in the receptacle 70 has inadvertently been exposed to a high moisture level some of the formulation may stick in the receptacle 70 and not be transferred to the bottle 79. In this situation, if the device 1 did not take account of this, the concentration of the resultant water/formulation mix would be incorrect, i.e. it would be weak, containing too much water for the transferred formulation. To avoid this, the microprocessor controller 22 may be provided with an additional input, namely for it to use the weighing mechanism 23 to sense the amount of powdered formulation actually transferred into the bottle 79. In this way, if the microprocessor controller realises that, for example, only 70% of the intended weight of powdered formulation has actually reached the bottle 79, it can reduce the amount of water to be transferred to the bottle so as to transfer only 70% of the intended water transfer, thereby ensuring that, although the volume of mixed feed in the bottle is less than was intended, at least the feed mixture is of the correct concentration.

In order to promote improved mixing the device 1 may discharge a portion of water into the bottle 79 prior to the powder being discharged into the bottle 79, with the bottle being “topped off” with the required amount of water after the powder has been transferred into the bottle.

Alternatively, or additionally, in order to reduce the above-mentioned problem of some of a dose of powdered formulation not being transferred to a bottle, the device 1 may be provided with an alternative construction of receptacle. A third embodiment of receptacle is referenced 40 and includes two main components: a ring 41 of (six) deformable “egg-shaped” compartments and a ring 42 of (six) openable closure portions—see FIGS. 6e, 6f and 7-9. Each openable closure portion is associated with a deformable compartment, as will be explained in more detail below.

In use, each compartment of the ring 41 has a dose of powdered formulation added thereto. This might be achieved by using a scoop to provide the relevant number of scoops of powdered formulation into each deformable compartment. Although the openings of the deformable compartments of the ring 41 are comparatively wide, thereby removing some of the prior art problem of accurately tipping scoops of powdered formulation into a container, this technique still has the problem that the user is required to keep count of the number of scoops being transferred.

An alternative, preferred technique for providing the compartments of the ring 41 with doses of powder is, thus, illustrated in FIGS. 6a-6f. In this technique a technique initially similar to that described above in conjunction with FIG. 4 may be employed, in that a tub 43 may be filled with an appropriate weight of powdered formulation (FIG. 6a), prior to the levelling of the formulation and the insertion therein of a multi-vaned element 44 (FIG. 6b) so as to divide the formulation into a plurality (six in the illustrated embodiment) of equal doses. Rather than applying a lid to the container 43, however, in the FIGS. 6a-6f technique the ring 41 of deformable compartments is applied over the top of the container 43, with each compartment in the ring 41 aligned with a compartment in the container 43 (FIG. 6c). By then inverting and shaking the combined elements 43, 44, 41 (FIG. 6d) each dose of powdered formulation may be transferred into a deformable compartment of the ring 41. Upon removing the container 43 the ring 42 of openable closure portions may be applied to, and locked to, the ring 41 of deformable compartments (FIG. 6e). After ensuring that the openable doors 45 of the ring 42 are in their closed positions (as they are in FIG. 6e), the ring assembly 40, 41 may be inverted (FIG. 6f).

At least the “egg-shaped” elements of the ring 41 of deformable compartments are, in the illustrated embodiment, made out of a substantially flexible material, such as silicone or rubber. As will be explained below, by deforming a compartment wall (i.e. by squashing the “egg” of an “egg-shaped” compartment), the powder within the compartment can be encouraged to fall to the base of the compartment and (if the door 45 of that compartment is opened) be delivered to a bottle 19. As a result, even if moisture has inadvertently entered the compartment, so causing the powdered formulation to agglomerate, it should be possible to cause all (or substantially all) of a dose of powdered formulation to be discharged from its storage compartment.

Although the components of the ring 41 are generally “egg-shaped” it will be appreciated that other shapes of compartment may be used.

FIGS. 8 and 9 show, schematically, a sequence of operations in which the deformable compartments of the ring 41 may be successively deformed (and their openable closures opened) so as to discharge their contents. FIG. 8 shows the receptacle 40 as further comprising a housing 46 having a window 47 and a plunger 48, which plunger is axially movable relative to the roof of the housing 46, to form a receptacle 40. The composite ring 41, 42 assembly of FIGS. 6e and 6f is received within the housing 46. As can be seen, the housing 46 is provided with a discharge portion 46a. When the receptacle 40 is mounted on the device 1 in the manner shown in FIG. 7 this discharge portion 46a is received in a powder-receiving conduit portion 78 in a manner similar to that of the discharge portion 76 of the receptacle 70 in the FIG. 5 embodiment.

FIGS. 8 and 9 show projections 49 integrally provided on the base of the plunger 48 and which are arranged to cooperate with respective compression springs 50. By pressing the plunger 48 down against the compression springs 50, the radially innermost compression spring 50 flips the openable closure 45 of the respective compartment from its closed position (FIG. 8) to its open position (FIG. 9) bringing the outlet 51 in the closure 45 into alignment with the body of formulation. At the same time axial movement of the plunger 48 deforms the wall of the respective compartment of the ring 41, thereby dislodging the powdered formulation through the outlet 51 provided in that compartment's openable closure 45. The dislodged charge of powdered formulation will fall through the discharge portion 46a and the aligned powder receiving conduit portion 78 of the device 1 into a bottle aligned therewith, such as the bottle 19 illustrated in FIG. 7. |In the FIG. 7 arrangement the bottle 19 is aligned with both the powder receiving conduit portion 78 and the water outlet 18 (not shown), in contrast to the FIG. 5f arrangement.

It is envisaged that one push of the plunger 48 will transfer one dose of powdered formulation into a bottle, and that releasing the plunger will cause the ring 41, 42 of the receptacle to index around (through 60° in the six compartment embodiment illustrated) to position a fresh, filled compartment in line with the plunger 48, so as to enable a further dose of powdered formulation to be discharged in due course.

It will be appreciated that the receptacle 40 illustrated in FIGS. 8 and 9 can (as shown in FIG. 7) be mounted on a food preparation device 1 in place of the receptacle 70 illustrated in FIG. 5f. As with the FIG. 5 embodiment of receptacle, although the illustrated version of the FIGS. 8 and 9 receptacle 40 is shown as being manually activated and indexed by user operation, it is envisaged that operation of the receptacle 40 may be controlled under the influence of the microprocessor controller 22 so as further to automate operation of the device 1.

As with the earlier embodiments, the receptacle 40 of FIGS. 6 and 8 may be used in conjunction with a device in which a fixed amount of water is discharged into a bottle containing a dose of powder formulation, based for example on a timer, volumetric flow or weight of water discharged. As earlier described, however, the device may be provided with more “intelligence”, in order to detect the amount of powdered formulation actually transferred into a bottle and to control the amount of water discharged into the bottle so as to ensure the right powdered formulation/water ratio.

In a yet further alternative arrangement, the formulation receptacle need not have pre-measured amounts of powdered formulation provided therein. Instead, the formulation receptacle may be a bulk reservoir 60 containing a bulk quantity of powdered formulation as illustrated schematically in FIGS. 10a, 10b and 11. By bulk quantity is meant a single amount representing, non-separated plural doses of powdered formulation. For example, the fourth embodiment of reservoir 60, illustrated in FIGS. 10 and 11, may contain an amount equivalent to 10 or 20 doses of powdered formulation.

The intention of the reservoir 60 is to remove the burden of manually dosing bottles. The reservoir 60 comprises three main components: lid 61, dosing wheel 62 and main reservoir body 63. As can be seen, the main reservoir body 63 includes a discharge portion 64 very similar to the discharge portions 46a and 77 of FIGS. 8 and 5 respectively, the intention of this discharge portion 64 being to fit into the powder receiving conduit portion 78 of the device 1 in the manner shown in FIG. 11 when the receptacle 60 is mounted on the device 1.

The dosing wheel 62 is rotatable relative to the main reservoir body 63 and is provided with a plurality of apertures 65. In FIG. 10a an aperture 65 is aligned with the discharge portion 64, allowing powder to pass into the discharge portion 64. In FIG. 10b the dosing wheel is rotated slightly, so that no aperture 65 is aligned with the discharge portion 64. By rotating the wheel 62 successively to pass the apertures 65 over the top end of the discharge portion 64, small amounts of the bulk amount of powder received in the reservoir 60 (the powder is omitted for reasons of clarity) may be successively dropped into the discharge portion 64 to fall through the powder receiving conduit portion 78 into a bottle 79.

By rotating the dosing wheel 62 about its central axis (either manually or, preferably, using a motor 66) it will be appreciated that predetermined amounts of formulation can be discharged from the reservoir 60 into the bottle 79, each predetermined amount being restricted by the volume (axial depth times plan area) of an individual aperture 65. The maximum volume of powder that can be transferred from the reservoir 60 by the passage of a single aperture 65 past the discharge portions 64 will be called the maximum predetermined amount of formulation per activation of the dosing wheel 62, this amount being substantially smaller than the size of a dose of preparation.

When it is desired to dispense a dose of powdered formulation using the arrangement illustrated in FIGS. 10 and 11, the motor 66 could be activated so as to rotate the dosing wheel 62. This would convey plural multiples of said “maximum predetermined amount of formulation per activation” to a bottle.

In order to discharge a dose of powdered formulation, the dosing wheel 62 might simply be revolved by the motor 66 a predetermined number of times, that number of times being known to transport a given weight or volume of powdered formulation. If, however, the powdered formulation does not “flow” in the manner expected, for example moisture ingress causes the powder to agglomerate, a feedback loop may advantageously be provided. For example, if the motor 66 is a stepper motor, the motor 66 could be initially energised so as to transfer powder rapidly from the reservoir 60 to the bottle 79 until the weighing mechanism informs the microprocessor controller that the weight of powder actually transferred has come close to the dose target “Y”. Suppose that the maximum amount of powdered formulation that can be dispensed per activation is the volume of one aperture 65 of the dosing wheel 62, which maximum predetermined amount of formulation we shall call “X”. The minimum amount of powder that could be dispensed per activation is zero, which would occur if powder completely failed to enter an aperture 65 of the wheel 62.

When the microprocessor senses that a weight equivalent to Y−0.5× has been discharged, then the microprocessor could instruct the stepper motor 66 to revolve the dosing wheel 62 to pass one further aperture 65 past the discharge portion 64. In the worst case scenario, the error would still be 0.5×, i.e. the actual amount of powder transferred could be as little as Y−0.5× or Y+0.5×. It is, however, more likely that the amount transferred would be somewhere between these two extreme values.

Rather than utilizing a dosing wheel 62 to regulate the flow of powder from the bulk supply the receptacle or the device may simply be provided with a valve or shutter for regulating powder flow in the manner of a slide valve in a coal delivery chute.

From the similarity of the views represented by FIGS. 5f, 7 and 11, it will be appreciated that the modular nature of the different embodiments of receptacles 70, 40, 60 illustrated therein enables different forms of receptacle to be mounted on the device. In each case, the mounting of the receptacle on the main body of the device provides the device with a facility which avoids the need for a user of the device to have to pre-dose a bottle by measuring out and transferring individual multiple level scoops of powder into a bottle, overcoming many of the disadvantages of the conventional multi-scoop techniques discussed in the introduction to the present specification.

In all of the above-discussed and illustrated embodiments the “mixing location”, at which the dose of concentrated food preparation formulation is mixed with (reheated) water is external to the device. What is meant by this is that mixing occurs after the reheated water has been discharged from the device (into a bottle received at a bottle receiving station).

It is, however, envisaged that the “mixing location” may be within the device. For example, where the device has a bottle-receiving station, this mixing location within the device would be upstream of the bottle-receiving station, so that the (reheated) water discharged to the bottle-receiving station would already have been mixed with concentrated food preparation formulation.

In this last regard, for example, in the manner of conventional instant coffee-making machines, a discrete dose of formulation might be provided in a receptacle that is mounted in or on the device. This receptacle may, for example, take the form of a sealed sachet. Upon associating the receptacle with the device, a closure of the receptacle would be arranged to be opened by the device on demand. This might, for example, involve a probe penetrating a membrane-like portion of the receptacle, this probe being hollow so as to admit (reheated) water into the receptacle on demand, thereby enabling the admitted water to mix with the receptacle's contents within the receptacle. In this situation the “mixing location” would be within the receptacle itself. In such an arrangement the mixed contents could then be removed from the receptacle, for example via another opening to be made in the receptacle, prior to being dispensed to a bottle externally of the device. Alternatively, the receptacle might be removed from the device with the mixed water/concentrated formulation contained therein so as to enable the food to be consumed by the user directly from the removed receptacle. In both cases it is envisaged that the removed receptacle would be discharged after use. It will be appreciated that this arrangement offers hygiene benefits, in that mixing occurs within a single-use receptacle. In addition, in the case in which the food is consumed from the receptacle in which mixing occurs, it will be appreciated that the mixed food's exposure is minimised to portions of the device which might previously have come into contact with mixed food upon a prior operation of the device.

In a modification of the above discussed arrangement of a sachet, whilst a single-use sachet would contain a dose of concentrated food preparation formulation, the mixing location would be external to the device. In such an arrangement it is envisaged that the sealed, single-use sachet would be inserted into the device prior to use. The sachet would then be breached, for example via a rupturable membrane, but rather than (reheated) water being introduced into the sachet, the intention would be that the dose of concentrated food preparation formulation would be dispensed from the sachet to a mixing location external to the device, for example to a bottle in the bottle-receiving station, at which mixing may take place.

In this regard, FIGS. 12a, 12b and 12c show a blister pack of six sachets in a single cartridge 104. A ring 102 of six deformable “egg-shaped” compartments is similar to ring 41 in FIG. 6. Each compartment contains a pre-measured dose of formulation and is closed by a rupturable membrane in the form of a single annular sheet 103 of moisture impermeable membrane sealed thereto. It will be appreciated that by employing the cartridge in an arrangement similar to that represented by reference numerals 42 and 46 in FIGS. 6-9, the contents of the six sachets may be sequentially accessed. In such an arrangement, mixing might take place in the device or externally of the device.

Although in the earlier illustrated embodiments the bottles take the form of rigid bottles of plastics material, there could be advantages if the bottles or containers were not rigid. For example, it is envisaged that a “bottle” may advantageously comprise a container whose internal volume is capable of being increased following unsealing of the container. What is envisaged is a “bottle” including a corrugation or fold. The “bottle” would have a dose of concentrated food preparation formulation dosed into it, for example at a factory or by a user at home, and then be sealed, with the “bottle” 110 in its reduced volume state—see FIG. 13a. In this state the external dimensions of the “bottle” would be smaller than if a rigid bottle were used. When it is desired to make up the feed in the “bottle”, the “bottle” could be unsealed and the walls of the “bottle” 110 pulled apart, in order to expand the “bottle”—see FIG. 13b. The expanded “bottle” could then have water of the appropriate temperature added to it, either from a kettle or from a device of the sort discussed earlier. It is envisaged that collapsible, pre-dosed “bottles” of this sort might have an advantage if a family is travelling away from home for a period of time and need to take a number of baby “feeds” with it. It is further envisaged that the “bottles” would be single-use devices, discarded after use.

In relation to all of the above discussed embodiments it is envisaged that any of the above-discussed receptacles could advantageously be provided with a form of “identification means”. The purpose of these identification means would be to provide information to the device 1 concerning the receptacle. For example, this information might be indicative of one or more of the following: the nature of the formulation contained in the receptacle; the number of discrete doses contained within the receptacle; and the size of the dose or doses contained therein. The identification means might take the form of a bar code, which is capable of being read by the device 1 when the receptacle is associated therewith. Alternatively, a number of projections might be provided on the exterior of the receptacle to interface with sensing elements provided on the device, to impart the necessary information to the device. Such identification means are known in relation to, for example, tape printing machinery and will thus not be described in detail here.

If, as discussed above, one of the inputs to the microprocessor controller 22 is the actual amount of powdered formulation transferred into a bottle, the microprocessor controller could compensate for under or over dosing of the bottle with powder.

Babies are recommended to drink an amount of sterilized water each day. It is envisaged that the above described devices can have a mode of operation in which solely reheated water is discharged so as to provide a ready supply of sterilized water for drinking.

Advantageously, the device would be able to provide an indication of the amount of water dispensed in a fixed time period.

It is also envisaged that the microprocessor controller may have numerous inputs to endow the device with “intelligence”. For example the device may measure (and display) room humidity, have an input for baby weight and even be able to have a “tell-tale” display to indicate when the device was last used and thus a baby last fed.

Except where incompatible with one another, any of the features described in conjunction with one embodiment are capable of being employed in any other embodiment. Furthermore, any of the features claimed in the claims dependent from the first independent claim annexed hereto should be regarded as being disclosed in combination with any of the features of the second independent claim and its dependent claims.

1-112. (canceled)

113. A food preparation receptacle for mounting in and/or on a food preparation device, the receptacle containing at least one discrete dose of concentrated food preparation formulation, which dose may be discharged from the receptacle on demand, wherein the receptacle is provided with identification means indicative of the contents of the receptacle and wherein the identification means is arranged to be read by a reader provided on the food preparation device when the receptacle is mounted in/or on the device.

114. A receptacle as claimed in claim 113, wherein the identification means is indicative of the nature of the formulation.

115. A receptacle as claimed in claim 114, wherein the identification means is alternatively or additionally indicative of the number of discrete doses contained within the receptacle.

116. A receptacle as claimed in claim 115, wherein the identification means is alternatively or additionally indicative of the size of said at least one dose.

117. A receptacle as claimed in claim 113, wherein the identification means takes the form of a bar code.

118. A receptacle as claimed in claim 113, wherein the identification means takes the form of a number of projections provided on the exterior of the receptacle to interface with sensing elements of the reader provided on the food preparation device.

119. A food preparation device constructed and arranged to have mounted therein and/or thereon a food preparation receptacle having the construction claimed in claim 113, the device comprising a said reader for reading the receptacle's identification means when the receptacle is mounted in and/or on the device.

120. A combination of a food preparation receptacle and a food preparation device, wherein the receptacle is for mounting in and/or on the food preparation device, the receptacle containing at least one discrete dose of concentrated food preparation formulation, which dose may be discharged from the receptacle on demand, wherein the receptacle is provided with identification means indicative of the contents of the receptacle and wherein the identification means is arranged to be read by a reader provided on the food preparation device when the receptacle is mounted in/or on the device and the device is constructed and arranged to have the receptacle mounted therein and/or thereon, the device comprising a said reader for reading the receptacle's identification means when the receptacle is mounted in and/or on the device.

121. A receptacle for mounting in and/or on a food preparation device and comprising at least two relatively movable parts, one said part defining a formulation discharge portion through which concentrated food preparation formulation may be discharged the from receptacle on demand, and the other said part comprising a housing, the interior of which housing is divided into a plurality of compartments each for containing a discrete dose of formulation, a said dose being selectively dischargeable from the receptacle in use by moving into registration the discharge portion and the compartment in which is contained the dose to be discharged.

122. A receptacle as claimed in claim 121, wherein said at least two parts are relatively rotatable.

123. A receptacle as claimed in claim 122, wherein said at least two parts are arranged to be relatively rotated by the food preparation device when the receptacle is mounted in and/or on the device.

124. A receptacle as claimed in claim 122, wherein said at least two parts are arranged to be relatively rotated by manual indexing when the receptacle is mounted in and/or on the device.

125. A receptacle as claimed in claim 121, wherein said at least two parts are moulded from plastics material.

126. A receptacle as claimed in claim 121, wherein said receptacle is dismountable from the food preparation device for refilling and/or replacement.

127. A receptacle as claimed in claim 121, wherein the receptacle is provided with a hub for mounting the receptacle in and/or on the food preparation device.

128. A receptacle as claimed in claim 121, wherein said plurality of compartments each contain a discrete dose of said formulation.

129. A food preparation device constructed and arranged to have mounted therein and/or thereon the receptacle of claim 121.

130. A combination of a receptacle and a food preparation device, wherein the receptacle is for mounting in and/or on the food preparation device and comprises at least two relatively movable parts, one said part defining a formulation discharge portion through which concentrated food preparation formulation may be discharged the from receptacle on demand, and the other said part comprising a housing, the interior of which housing is divided into a plurality of compartments each for containing a discrete dose of formulation, a said dose being selectively dischargeable from the receptacle in use by moving into registration the discharge portion and the compartment in which is contained the dose to be discharged, and the device is constructed and arranged to have the receptacle mounted therein and/or thereon.

131. A food preparation device, comprising:
at least one water chamber for the controlled dispensation therefrom of water to a bottle-receiving station;
a water dispensation controller for controlling the dispensing of water from said at least one chamber to the bottle-receiving station; and
a weighing apparatus associated with the bottle receiving station to determine the weight of a received bottle and any contents of the bottle;
wherein the water dispensation controller is arranged to control the dispensing of water to the bottle-receiving station according to weight information received from the weighing apparatus.

132. A device as claimed in claim 131, wherein the weighing apparatus is constructed and arranged to determine the weight of any food preparation formulation in the bottle at the bottle-receiving station and the water dispensation controller is configured to match the amount of water dispensed to the determined weight of the bottle's food preparation formulation so as to produce within the bottle an amount of mixed food of a predetermined concentration of formulation to water.

133. A device as claimed in claim 132, further comprising:
a formulation receptacle for containing food preparation formulation; and
a formulation dispenser for dispensing formulation from said receptacle to said bottle-receiving station.

134. A device as claimed in claim 133, wherein the formulation dispenser and the water dispensation controller are configured to match the amount of formulation and water dispensed to the bottle-receiving station so as to produce at the bottle-receiving station mixed food of a predetermined concentration of formulation to water.

135. A device as claimed in claim 131, wherein the water dispensation controller is provided with a manual override to enable manual intervention in the dispensation of water.

136. A device as claimed in claim 131, wherein the water dispensation controller includes a microprocessor controller.

137. A device as claimed in claim 131, further comprising a water flow measurement device for measuring the amount of water dispensed to the bottle-receiving station from said at least one water chamber.

138. A device as claimed in claim 137, wherein the water dispensation controller is arranged to control the dispensing of water according to the volume of water dispensed, as measured by the water flow measurement device.

139. A device as claimed in claim 131, further comprising a timer for timing the duration of water dispensation to the bottle-receiving station from said at least one water chamber.

140. A device as claimed in claim 139, wherein the water dispensation controller is arranged to control the dispensing of water to the mixing location according to timing information received from the timer.

141. A device as claimed in claim 131, wherein the device is constructed and arranged so that both formulation and water dispensed to the bottle-receiving station can be dispensed directly into a bottle received in the bottle-receiving station.

142. A device as claimed in claim 141, wherein the bottle-receiving station is adapted to receive a bottle of a type suitable for administration of the dispensed water/preparation, when dispensed to and then mixed in a bottle, to a baby or infant directly from the bottle.

143. A combination of the food preparation device of claim 131 and a food preparation receptacle for mounting in and/or on the food preparation device, the receptacle containing at least one discrete dose of concentrated food preparation formulation, which dose may be discharged from the receptacle on demand, wherein the receptacle is provided with identification means indicative of the contents of the receptacle and wherein the identification means is arranged to be read by a reader provided on the food preparation device when the receptacle is mounted in/or on the device.

144. A combination as claimed in claim 143, wherein the receptacle is mounted in and/or on the device.

145. A combination of a food preparation device and a receptacle, wherein the food preparation device comprises:
at least one water chamber for the controlled dispensation therefrom of water to a bottle-receiving station;
a water dispensation controller for controlling the dispensing of water from said at least one chamber to the bottle-receiving station; and
a weighing apparatus associated with the bottle receiving station to determine the weight of a received bottle and any contents of the bottle;
wherein the water dispensation controller is arranged to control the dispensing of water to the bottle-receiving station according to weight information received from the weighing apparatus; and
the receptacle is for mounting in and/or on the food preparation device and comprises at least two relatively movable parts, one said part defining a formulation discharge portion through which concentrated food preparation formulation may be discharged the from receptacle on demand, and the other said part comprising a housing, the interior of which housing is divided into a plurality of compartments each for containing a discrete dose of formulation, a said dose being selectively dischargeable from the receptacle in use by moving into registration the discharge portion and the compartment in which is contained the dose to be discharged.

146. A combination as claimed in claim 145, wherein the receptacle is mounted in and/or on the device.
